(19) United States
(12) Patent Application Publication
(10) Pub. No.: US 2025/0375277 A1
(43) Pub. Date: Dec. 11, 2025

(54) Prophy Angle Assembly for Cleaning Teeth with Braces

(71) Applicant: Ajay Kumar, Summerville, SC (US)

(72) Inventor: Ajay Kumar, Summerville, SC (US)

(21) Appl. No.: 18/735,052

(22) Filed: Jun. 5, 2024

(51) Int. Cl. A61C 17/22; A46B 9/04; A46B 13/02; A46B 15/00; A46D 1/00; A46D 3/00

(52) U.S. Cl. CPC A61C 17/222; A46B 9/04; A46B 13/02; A46B 15/0048; A46D 1/0238; A46D 3/005

(57) ABSTRACT

The present invention discloses a prophy angle assembly for cleaning teeth with braces comprising a housing installed with a driving mechanism including a driven gear and driving gear. A cup is co-molded with the driven gear enclosing a plurality of bristles having tips extending from a surface of the cup. A gap is formed between an inner wall of the cup and the bristles. A splatter guard is attached to the housing and positioned in constant contact with the cup to prevent splatter while cleaning of dental arcade.

### FIELD OF THE INVENTION

The present invention relates to the field of dentistry tools. More specifically, the present invention relates to a prophy angle assembly for cleaning teeth with braces.

### BACKGROUND OF THE INVENTION

With the increasing awareness of dental hygiene, a variety of dentistry tools have been developed to ensure thorough cleaning of the dental arcade. Among these tools is the prophy angle, a small, handheld instrument used by dentists for performing teeth cleaning procedures, also known as prophylaxis. These procedures typically involve polishing the surfaces of the teeth, removing plaque and stains, and leaving the teeth clean and smooth. The prophy angle is typically attached to a dental handpiece and equipped with a rotating or oscillating rubber cup and a brush.

U.S. Pat. No. 8,784,102B1 describes a prophy cup with dimples on its outer surface aimed at increasing turbulent flow and minimizing fluid ejection during dental cleaning. The housing of the dental hand piece splits longitudinally to position a wiper near the cup's surface, which removes slurry as it rotates thus further reducing fluid ejection. The blade edge of wiper conforms to cup's contour, effectively removing fluid and preventing accumulation on the surface.

Another US patent document, U.S. Pat. No. 5,131,846 discloses a cylindrical prophy cup shield attached to a dental hand piece via elastic fit around the hand piece's nose. The interior of the shield features spiral tracks that work with the rotating cup to expel any trapped paste. This shield prevents splatter of cleaning paste and bodily fluids from the patient. Moreover, it extends beyond the circumferential rim of the rotating cup.

Additionally, U.S. Pat. No. 6,099,309 describes a disposable prophy cup with a plurality of concentric rings within its inner cup, aiding in splatter elimination. These rings, made of cloth or felt, vary in abrasiveness with the most abrasive located at the cup's deepest portion. The inner core of the cup may also contain numerous relatively short bristles for enhanced abrasion.

In U.S. Pat. No. 7,255,559 (2007), Wang et al describe a horseshoe retainer for holding the whole assembly in place. Also, Wang et al, in a further patent no. WO2016014065A1 (2014), discloses the same horseshoe retainer with identical verbiage.

Further, in a pending patent US20230013866A1 (2021), Wang et al disclose a retainer having the same verbiage as that in his previous documents designed to hold the assembly. However, Wang's horseshoe retainer design as described and patented in three patents is mainly focused on supporting the drive shaft. Also, one major shortcoming of Wang's retainer is that it was very easily pulled out and did not firmly latches within the housing. This made the workers never know if the retainer was attached properly or not.

Individuals with braces are indeed at a higher risk of developing gingivitis compared to those without braces. This increased risk is primarily due to the challenges associated with maintaining proper oral hygiene while wearing braces. The braces create additional surfaces and spaces where food particles and plaque can accumulate, especially around brackets, wires, and orthodontic bands. If not removed effectively through brushing and flossing, this plaque buildup can lead to irritation and inflammation of the gums, which is characteristic of gingivitis. These patients sometimes also develop stains on the occlusal table.

Further, the wires and brackets of braces can make it more difficult to clean between teeth and along the gum line, which are essential areas for preventing gingivitis. As a result, individuals with braces must be particularly diligent in their oral hygiene practices to minimize the risk of developing gingivitis. For such, issues the patients require regular visits to the orthodontist for adjustments and cleanings can also help reduce the risk of gingivitis by addressing any issues with the braces that may contribute to plaque buildup or gum irritation.

The Standard prophy brush can clean the buccal and lingual face of teeth adequately, they are generally not as well suited to provide adequate removal of plaque and debris from the interproximal areas and other hard-to-reach regions of the mouth since penetration into interdental spaces is still relatively difficult. On the other hand, the prophy brush with tufts is not well suited to sufficiently clean the gingival margin as it can create damage to the gingiva but is an excellent tool to clean interdental spaces, occlusal surfaces, and hard-to-reach areas behind the braces, where typically plaque would build up.

Thus, if a clinician just uses the prophy brush on patients with braces they would not be able to clean the gingival groove (the gap between teeth and periodontium), which will lead to gingivitis. It is known that the buildup of plaque in the gingival groove can cause gingivitis, i.e., inflammation of the gum tissue. The brush design currently does not address this critical shortcoming. Furthermore, the brushes are notoriously loud as they are not enclosed and as they go over the braces they make slapping sounds which startles the patient. The known prophy brushes are approximately 4 millimeters in diameter and may rotate at speeds up to 5,000 RPM, exerting enormous centrifugal force and changing inertial forces as the bristle tufts travel over braces, pits, and fissures.

Due to the enormously developed centrifugal force, splatter occurs because the cleaning paste is applied on the outside of the cleaning bristles and there is nothing to prevent this paste from spreading/flying off due to the rotation of the brush. The prophy bristles are rotating and changing directions as they traverse over the braces, this is further compounded by the fact that there is no mechanism to retent the cleaning paste.

Further, the rotational movement of the prophy bristle generates centrifugal force, combined with the sudden change in bristle geometry as it goes over the bracket from straight to bent and then back straight again. This flexion in the bristles' geometry generates a change in moment of inertia, that can lead to the dislodgement of paste particles and debris from the surface of the braces and in addition non-retention of the paste from the bristle. Not only can the cleaning paste but the saliva and blood of the patient can fly and spread separately from the bristles during the procedure and create splatter.

Furthermore, the opaque cup of conventional prophy angles obstructs the clinician's view and restricts precise maneuvering around braces On the other hand, a prophy cup provides a superior clean and polish sub gingivally they flare and reach under the gum line. However, the prophy cup is a poor choice when it comes to cleaning braces and/or occlusal surfaces with stains. Hence, both systems suffer from shortcomings including the problem of splatter.

Prophy brushes and/or rubber cones (terminating in a point) are used to clean occlusal pits and fissures, remove stains around orthodontic appliances, and clean hard-to-reach interproximal spaces. They are also used for polishing and removing heavy stains. Prophy brushes are available in a variety of lengths and styles. However, prophy brushes are a poor choice when it comes to cleaning below the gum line. Since the paste is applied on the outside of the prophy brushes, it causes the paste to get detached and cause splatter as soon as the prophy brush starts to rotate due to centrifugal forces. Additionally, conventional prophy brushes are ineffective in distributing and retaining cleaning paste due to poor design, resulting in inconsistent application, retention, and inadequate coverage of tooth surfaces. The existing designs of prophy cups and bristles are not optimally configured to secure and distribute paste onto the tooth surface, leading to paste dislodgement and inadequate dispersal during use, resulting in uneven cleaning and reduced efficiency.

Therefore, there is a pressing need for an improved prophy angle brush that enhances patient comfort and optimizes clinical outcomes especially when it comes to cleaning patients' teeth who have braces and/or have stains on the occlusal table. A prophy angle with a streamlined design that addresses various dental procedures, particularly prophylaxis procedures, is highly desirable.

### Objectives of the Invention

A primary objective of the present invention is to address the challenges encountered in prior art.

A particular objective of the present invention is to develop a prophy angle that significantly reduces or eliminates splatter generation during the cleaning of patients with braces and/or occlusal tables with heavy stains, thereby minimizing the spread of fluids and contaminants during dental procedures. This reduction in splatter aims to eliminate infectious agents, promoting a safer clinical environment.

Another objective of the present invention is to design a prophy angle with increased flexibility that can be used as they are contained inside the enclosing means, allowing bristles to flex as they go over the braces and/or occlusal table, enabling it to effectively reach complex areas of the tooth arcade for thorough cleaning.

Additionally, the invention aims to enhance paste retention and distribution around the bristles of the prophy brush, ensuring consistent coverage of tooth surfaces and improving cleaning efficiency.

Moreover, the objective is to develop a prophy angle that offers ease of handling, smoother dental operations, and reduced noise levels, thus alleviating patient discomfort and anxiety during procedures. Keeping bristles confined in the cup also reduces noise transmission as they flex and change directions as they go over the braces.

The invention also seeks to provide clinicians with better visibility of the teeth with braces, facilitating precise maneuvering of the prophy angle during dental procedures.

Furthermore, the aim is to develop a prophy angle that enables clinicians to perform dental procedures with reduced sound levels, greater efficiency, and precision, reducing tediousness.

An additional objective is to minimize the risk of procedural complications and achieve long-term cost savings for dental procedures.

Also, the invention aims to design a prophy angle with an ergonomic structure, reducing strain and fatigue on clinicians during dental procedures, thereby enhancing comfort and productivity.

### SUMMARY OF THE INVENTION

The present invention pertains to a prophy angle designed to minimize splatter during cleaning of ortho patients with braces and/or patients with heavy occlusal stains to streamline dental procedures, ensuring a quieter process as bristles are confined inside the prophy cup thereby attenuating sound while optimizing paste retention for consistent coverage of tooth buccal and lingual surfaces with braces. These advancements synergistically enhance cleaning efficiency, ultimately reducing patient discomfort and anxiety associated with such procedures.

According to an embodiment, a prophy angle assembly for cleaning teeth with braces and/or occlusal table comprises a housing installed with a driving mechanism featuring a driven gear and a driving gear, a cup removably attached to an end of the housing. A plurality of bristles have tips extending from the driven gear and are enclosed by the cup, in a manner that there is a gap is formed between an inner wall of the cup and the bristles. The length of the bristles is at least 50% of the cup's length, such that the gap formed between the bristles and the inner wall of the cups is located near an open end of the cup. A splatter guard is attached to the housing to prevent splatter while cleaning the dental arcade.

According to another embodiment of the present invention, the cup is made of a transparent and flexible material for providing clear visibility of the dental arcade to be cleaned along with flexible movements of the cup while cleaning the dental arcade.

According to another embodiment of the present invention, the length of the bristles is up to 125% of the length of the cup.

According to another embodiment of the present invention, the bristles are co-molded with the driven gear and/or glued to the driven gear.

According to one another embodiment of the present invention, the splatter guard is attached to the housing via a locking retainer.

According to another embodiment of the present invention, the splatter guard comprises one or more contact edges.

According to another embodiment of the present invention, at least one edge is always in constant contact with an outer surface of the cup upon rotation and flexion of the cup, as it flexes when pressed against the tooth surface and/or braces.

According to another embodiment of the present invention, the locking retainer comprises a body having a curved surface, featuring a longitudinal protrusion extending along each of a lateral edge of the curved surface.

According to another embodiment of the present invention, each longitudinal protrusion is adapted to resiliently flex and retract, allowing the body to be securely inserted into an opening of the housing.

According to another embodiment of the present invention, on inserting the body within the opening, the longitudinal protrusions expand to latch into the opening, to provide a firm and secure connection to the splatter guard within the opening to prevent the accidental removal of the splatter guard.

According to a further embodiment of the present invention, the driving gear is engaged perpendicularly with the driven gear.

According to another embodiment of the present invention, the driving gear is a shaft with an end fabricated in a gear tooth profile.

In yet another embodiment of the present invention, the driving gear is actuated by an air-driven hand-piece to provide motion to the driven gear for actuating the bristles.

### BRIEF DESCRIPTION OF THE DRAWINGS

FIG. 1 illustrates an exploded view of a prophy angle assembly for cleaning teeth with braces and/or dental occlusal tables with heavy stains, in accordance with an embodiment of the present disclosure;

FIG. 2 illustrates an assembled transparent view of the prophy angle assembly of FIG. 1:

FIG. 3 illustrates a partial view of the prophy angle assembly of FIG. 1, in accordance with another embodiment of the present disclosure:

FIGS. 4A-D illustrate different views of a splatter guard of the prophy angle assembly of FIG. 1, in accordance with another embodiment of the present disclosure:

FIG. 5A illustrates a front view of the splatter guard of FIG. 4 in connection with a prophy cup of the prophy angle assembly in a stationary state, in accordance with another embodiment of the present disclosure:

FIG. 5B illustrates a front view of the splatter guard of FIG. 4 in connection with the prophy cup in an operational state, in accordance with another embodiment of the present disclosure:

FIG. 5C illustrates a front view of the splatter guard of FIG. 4 in connection with the prophy cup with one contact edge, in an operational state, in accordance with another embodiment of the present disclosure:

FIG. 6 illustrates a perspective view of a locking retainer of the prophy angle assembly, in accordance with another embodiment of the present disclosure; and

FIG. 7 illustrates a sectional view of a connection between the locking retainer of FIG. 6 and the splatter guard of FIGS. 4A-4D, in accordance with another embodiment of the present disclosure.

### DETAIL DESCRIPTION OF THE INVENTION

The embodiments herein and the various features and advantageous details thereof are explained more fully with reference to the non-limiting embodiments that are illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in this application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The present invention relates to a prophy angle assembly for cleaning teeth with braces. facilitating the clinicians to perform the dental procedure in a non-tedious, precise manner while controlling the splatter, thereby providing a comfortable and enhanced experience to both the clinicians and the patient.

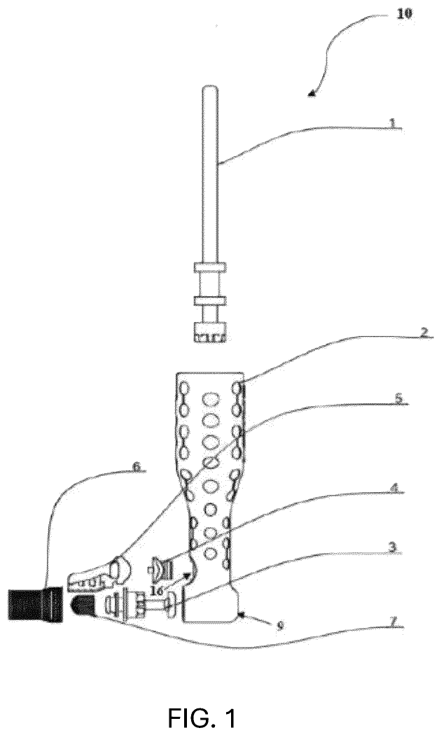

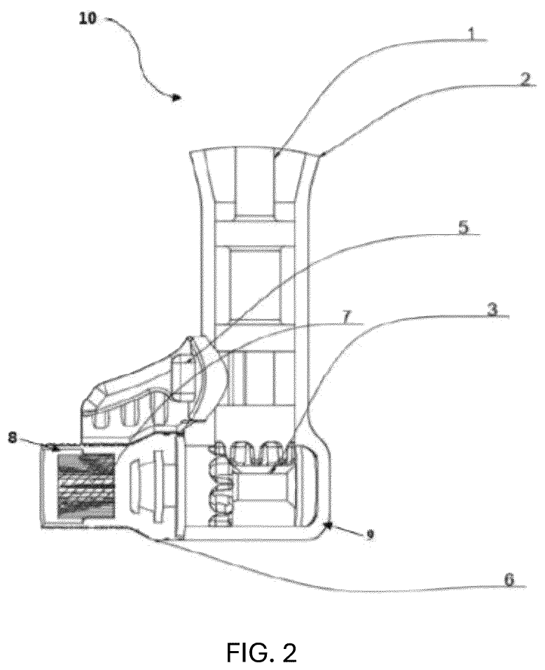

Referring to FIGS. 1 and 2, a prophy angle assembly 10 as shown includes a housing 2. The housing 2 can be made of any sturdy material such as metal, plastic, or polymer. In an embodiment, the housing 2 has a cylindrical portion at an operational bottom portion and a tapered portion extending above the cylindrical portion. The housing 2 acts as a handle to provide a convenient grip to a clinician for handling and positioning a translucent cup 6.

In one embodiment, the cup 6 has a tapered structure made of a flexible, material such as engineering resin, rubber derivatives, and the like having a particular thickness. In a further embodiment, the material of cup 6 is also transparent/translucent. Further, the cup 6 includes multiple see-through dimples protruding from its outer surface that act as plano-convex lenses. These dimples offer clinicians clear visibility to precisely position the cup 6 over the braces and/or on the occlusal table for cleaning.

In another embodiment, the cup 6 co-molded with driven gear is at 90 degrees or more with respect to the tapered end of the housing 2 at an angle, for the practitioners to offer easy maneuverability inside the mouth. The cup 6 has an outward taper, such that the cup 6 can be colored or without color. The angle of the taper may range from 1 to 25 degrees, preferably 3 to 9 degrees, and most preferably about 4-7 degrees outward taper. The outward taper causes the cup 6 to collapse on itself and allows a plurality of bristles 7 to come in contact with teeth.

Further, the housing 2 includes a drive mechanism having a driving gear 1 and a driven gear 3. The driving gear 1 comprises a shaft with an end fabricated with a gear tooth profile and meshed with the driven gear 3 to provide motion to the driven gear 3. Further, the driven gear 3 may include a spur gear, a bevel gear, a pinion gear, and the like. In an embodiment, a plurality of bristles 7 and the cup 6 is co-molded and/or glued with the driven gear 3.

In an embodiment, the driven gear 3 is positioned inside the housing 2, near the free tapered end, and is engaged perpendicularly to the driving gear 1. The driving gear 1 is adapted to be engaged with an air-driven hand-piece (not shown here) that sets the driving gear 1 in motion which is passed to the driven gear 3 with the bristles 7 to initiate a dental cleaning operation. In an embodiment, the handpiece may be a battery-powered device.

In another embodiment, the bristles 7 are thin, colored hair-like projections extending from a planar surface of the driven gear 3 and/or inside of the cup 6. The bristles 7 have tips with a diameter ranging between 0.02 mm to 0.35 mm, such that the bristle diameter can range from 0.02 to 0.16 mm for ultrasoft, 0.16 to 0.22 mm for soft, 0.23 to 0.29 mm for medium, and 0.30 mm and above for hard. The bristles 7 extend outward from the surface of the driven gear 3 and through the cup 6 attached to the driven gear 3 such that the cup 6 circumferentially surrounds the bristles 7 and rotates with the driven gear 3.

In a further embodiment, the length of the bristles 7 is at least 50% of the length of the cup 6. In another embodiment, the length of the bristles 7 is up to 125% of the length of the cup 6. For example, one can use soft bristles for pits and fissures and/or medium for braces, and/or ultrasoft for pediatric patients. The other three types of bristle ends coarse cut, enlarged bulbous, and round, the round end of the bristle type of choice because it is associated with a lower incidence of gingival tissue irritation. The soft bristles 7 are preferable because of the decreased likelihood of gingival tissue trauma and increased interproximal cleaning ability.

The preferred shape of the bristles is an X-shaped cross-sectional area and/or a diamond-shaped or a triangular-shaped cross-sectional shape for cleaning during prophy procedure due to improved cleaning properties, better interdental penetration, enhanced plaque removal, increased stability, adaptability to tooth contours, and a soft feeling during brushing.

In an embodiment, a gap 8 is formed between an inner wall of the cup 6 and the plurality of bristles 7. The gap 8 helps retain the cleaning paste used for dental cleaning for a longer duration during the cleaning process. This gap 8 refers to the packing factor. The lower packing factor between the cup and the bristles allows more paste to be retained between the cup and the bristles. The packing factor helps in retaining paste and preventing paste from being easily washed away during the polishing procedure. A lower packing factor or gap 8 within a specific range allows for an increased specific void volume within the bristles 7, enabling increased uptake of polishing paste and improved capillary action for better retention and delivery of polishing paste during the procedure.

By having x-cross sectional-shaped bristles 7 inside the cup 6, the paste can be retained. The packing factor 8 helps in retaining polishing paste and preventing it from being easily washed away during the polishing procedure. A lower packing factor within a specific range allows for a higher specific void volume within the bristles, enabling increased uptake of paste and improved capillary action for better retention and delivery of dentifrice during polishing. The cross-sectional shape of the filaments in the bristles 7 of the first type helps in getting interproximal by improving cleaning properties, reaching and cleaning hard-to-reach areas, and providing a better sensory feeling during the polishing process.

In another embodiment, the cross-sectional shape of the bristles can preferably a trilobal and/or diamond-shaped. The profiled edges other than the circular cross-sectional shape filaments provide a stronger scraping action without requiring much pressure, improving plaque removal. The filaments are designed to reach and clean interdental spaces and other hard-to-reach areas. This specific geometry of filaments allows for optimal interdental penetration and adaptability to tooth and gum contours.

The filaments other than circular cross-sectional shapes also have a low packing factor/gap 8, enabling increased uptake of paste and loosened plaque. Thus overall, the cross-sectional shape enhances the cleaning effectiveness and reach of the toothbrush, particularly in interproximal spaces. The filaments with a specific geometry can be made with different possible materials with Polyamide (nylon) which are commonly used due to their durability and flexibility. Polybutylene terephthalate (PBT): PBT filaments are also commonly used in toothbrushes for their stiffness and resistance to wear. Thermoplastic elastomer (TPE): TPE filaments provide a softer and more flexible brushing experience and elastomeric materials as rubber, may be used for filaments that provide a massaging effect on the gums. This would be preferred for the pediatric patients.

The shaped bristles may be coated with Kaolin clay to increase the abrasiveness of the bristles. Additionally, the standard bristles with circular cross-sections do not provide sufficient capillary effects to remove plaque and debris underneath braces as their packing efficiency is close to 100% (i.e., no gap between bristles and cup 6, hence no capillary action. Thus, to achieve good cleaning results under the braces, the plaque must be within reach of the bristles, so plaque can be disrupted and removed. In the current bristles' design, the prophy brush has 100% packing efficiency. In this design, bristles 7 are diverging 4 degrees with respect to a longitudinal axis of the driven gear 3, thereby decreasing the packing efficiency and allowing more uptake of the paste.

Further, the prophy angle assembly 10 includes a splatter guard 5 adapted to be attached to the housing 2 to prevent splatter during a cleaning process. The splatter guard 5 is attached to the housing 2 via a locking retainer 4 which is adapted to be inserted into an opening 16 of the housing 2. This locking retainer 4 also prevents the accidental removal of the splatter guard 5 during the cleaning process.

In an embodiment, the splatter guard 5 is kept in constant contact with the outer surface of the cup 6 to prevent the misalignment of the cup 6 while flexion and rotation of the bristles 7 and the cup 6 during a cleaning procedure.

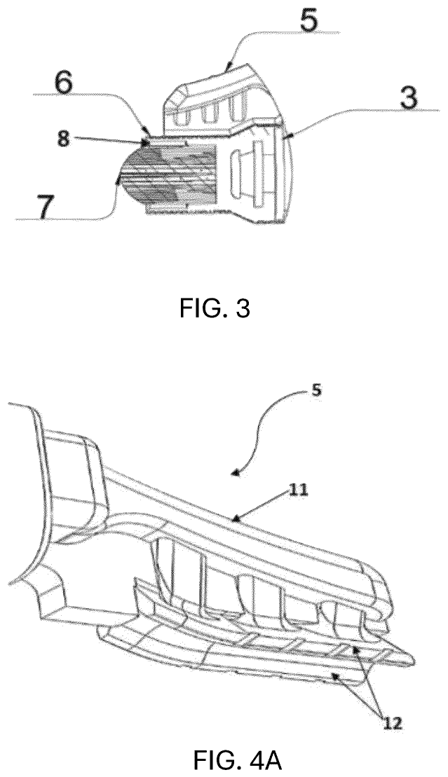

FIG. 3 illustrates a partial view of the prophy angle assembly 10 showing a different arrangement of the cup 6, the bristles 7, and the splatter guard 5. In the present embodiment, the cup 6 encloses the plurality of bristles 7 extending from a planar surface of the driven gear 3 and having a length more than the height of the cup 6. In an embodiment, the length of the bristles 7 is up to 125% of the height of the cup 6. Also, the bristles 7 have a rounded end, providing comfort and easy reach to the complex areas of the dental arcade.

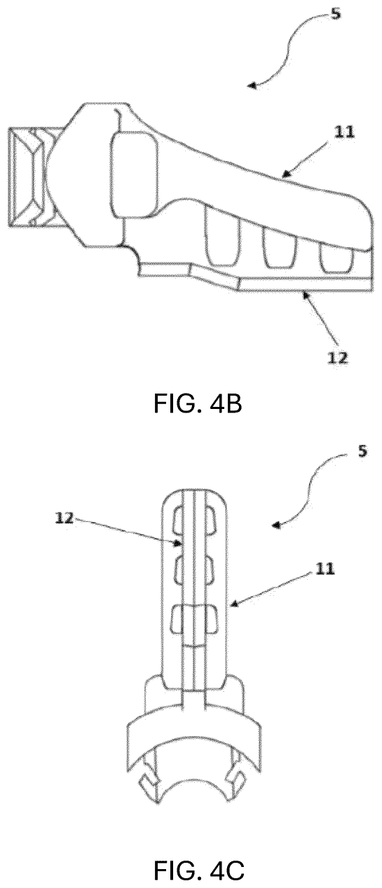

FIGS. 4A-4D illustrate different views of the splatter guard 5 including a perspective view, a side view, a top view, and a front view, in accordance with an embodiment. As shown, the splatter guard 5 has a guard body 11 having a tapered structure. Further, the splatter guard 5 includes one or more contact edges 12 adapted to provide constant contact during cup 6 flexion when it is being pushed against the tooth surface and/or dental brace with the outer surface of the cup 6 to prevent splatter.

In an embodiment, the contact edges 12 extend longitudinally from the side portions of the splatter guard 5, forming a fin-shape structure that allows more efficient cleaning of the cup 6. Due to the constant contact with the cup 6, the splatter guard 5 provides a firm grip to the cup 6, thus preventing misalignments of the cup 6 during operation. The splatter guard 5 has a snap-fit type attachment for attachment to the housing 2. However, other suitable attachment fits are also feasible. The splatter guard 5 is adapted to be aligned for use with a clockwise or a counter-clockwise prophy handpiece. In an embodiment, the splatter guard has only one contact edge (as illustrated in FIGS. 4C and 4D)

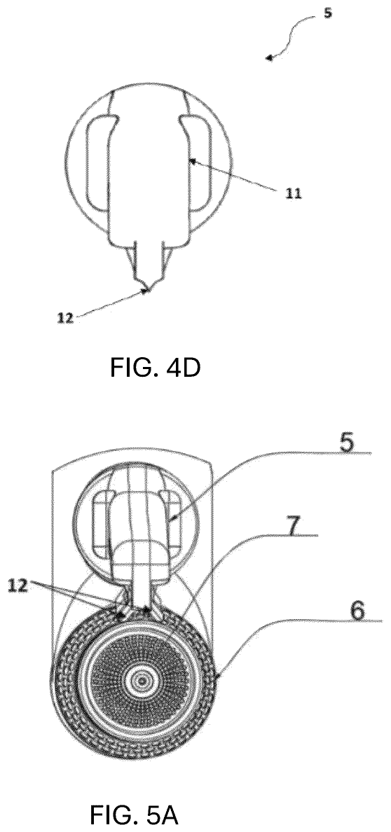

Referring to FIG. 5A-5C, a front view of the splatter guard 5 in connection with the cup 6 in different states is shown. In FIG. 5A, when the prophy angle assembly 10 is not in operation, the contact edges 12 are in contact with the outer surface of the cup for supporting the cup 6. In FIG. 5B, in an operational state, the splatter guard 5 tilts at an angle due to the rotation of the cup 6. In either case, the contact edges 12 remain in contact with the outer surface of the cup 6. Due to the constant contact of contact edges 12 with the cup 6, the cup 6 experiences stable support all the time while the splatter produced is also significantly reduced. In another embodiment, only one contact edge of the splatter guard 5 is in contact with the outer surface of the cup 6 as shown in FIG. 5C, due to the single-edge contact the friction between the cup 6 and the contact edge of the splatter guard 5 is reduced.

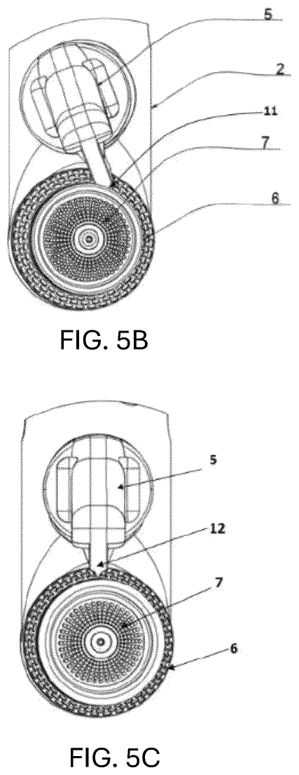

FIG. 6 illustrates a perspective view of the locking retainer 4. The locking retainer 4 includes a retainer body 13 with a curved profile 14. The curved profile 14 features a longitudinal protrusion 15 extending along each lateral edge of the curved profile 14. The longitudinal protrusion 15 may flex and retract resiliently, allowing the retainer body 13 to be securely inserted in the opening 16.

When the locking retainer 4 is inserted within the opening 16 of housing 2, the longitudinal protrusions 15 expand to latch into the opening 16 to provide a firm and secure connection to the retainer-body 13 within the opening 16. Further, the retainer-body 13 comprises an attachment end 17 for securing the splatter guard 5 with the locking retainer 4 to attach the splatter guard 5 with the housing 2, thereby preventing accidental removal of splatter guard 5 due to the flexion of the cup 6.

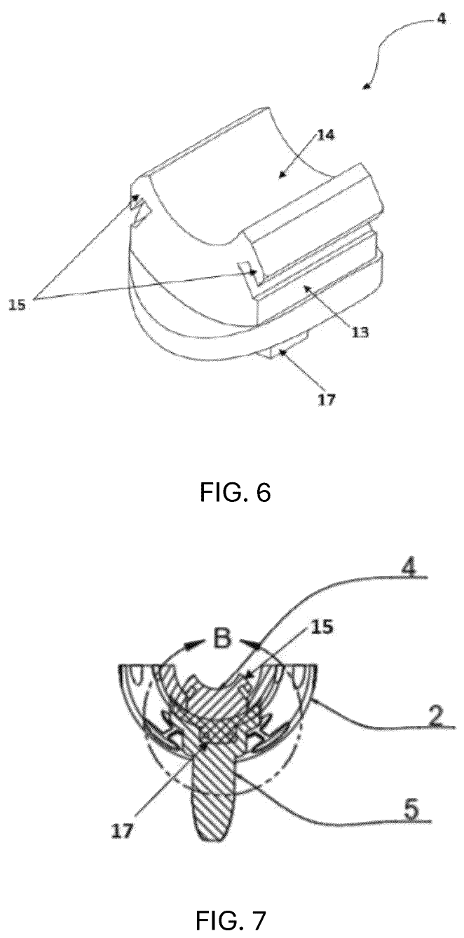

FIG. 7 illustrates a sectional view of the connection of the locking retainer 4 and the splatter guard 5. The splatter guard 5 is attached in a manner that the attachment end 17 of the locking retainer 4 gets fitted to a groove of the splatter guard 5, in order to fix the splatter guard 5 with the locking retainer 4. The assembly of the locking retainer 4 with the splatter guard 5 is then connected within the opening 16 of the housing 2, thereby allowing convenient attachment of the splatter guard 5 with the housing 2.

The preceding description of specific embodiments fully reveals the general nature of the embodiments herein, enabling others to readily modify and adapt such embodiments for various applications using current knowledge. These adaptations and modifications are intended to be comprehended within the scope of the generic concept, and it is understood that the phraseology or terminology used herein is for descriptive purposes and not for limitation. While the embodiments herein have been described in terms of preferred embodiments, those skilled in the art will recognize that the embodiments herein can be practiced with modifications within the spirit and scope of the appended claims.

We claim:

1) A prophy angle assembly for cleaning teeth with braces, the prophy angle assembly comprising:
a housing incorporating a driving mechanism, wherein said driving mechanism comprises a driven gear and a driving gear;
a translucent cup co-molded with driven gear, it can be colored or without color;
a plurality of bristles having tips extending from a surface of said driven gear,
wherein said bristles are enclosed by said cup, and a gap is formed between an inner wall of said cup and said bristles; and
a splatter guard attached to said housing to prevent splatter while cleaning said dental arcade.

2) The prophy angle as claimed in claim 1, wherein said cup is made of a transparent and/or translucent and flexible material.

3) The prophy angle as claimed in claim 1, wherein a length of said bristles is at least 50% of a height of the cup, such that the bristles are parallel to a longitudinal axis of said driven gear or diverging between 1-15 degrees.

4) The prophy angle as claimed in claim 1, wherein said bristles have a preferred cross-sectional shape of X-shaped and/or diamond-shaped structure or a round sectional shape.

5) The prophy angle as claimed in claim 3, wherein said bristles are slightly diverging between 2-10 degrees to allow paste to get intact between said gap.

6) The prophy angle as claimed in claim 1, wherein a length of said bristles is up to 125% of a height of said cup.

7) The prophy angle as claimed in claim 1, wherein said bristles are glued to the cup's inside surface but can also be co-molded with the cup.

8) The prophy angle as claimed in claim 1, wherein said splatter guard is attached to said housing via a locking retainer.

9) The prophy angle as claimed in claim 1, wherein said splatter guard comprises one or more contact edges.

10) The prophy angle as claimed in claim 1, wherein upon rotation of said cup during teeth cleaning, with or without braces, at least one edge of said one or more contact edges is always in constant contact with an outer surface of said cup.

11) The prophy angle as claimed in claim 8, wherein said locking retainer comprises a body with a curved profile, featuring a longitudinal protrusion extending along each of a lateral edge of said curved surface.

12) The prophy angle as claimed in claim 11, wherein each of said longitudinal protrusions is adapted to flex and retract resiliently allowing said body to be securely inserted into an opening of said housing.

13) The prophy angle as claimed in claim 12, wherein upon inserting said body in said opening, said longitudinal protrusions expand to latch into said opening, to provide a firm and secure connection to said splatter guard within said opening, thereby preventing accidental removal of said splatter guard.

14) The prophy angle as claimed in claim 1, wherein said driving gear is engaged perpendicularly with said driven gear.

15) The prophy angle as claimed in claim 1, wherein said driving gear is a shaft with an end fabricated in a gear tooth profile.

16) The prophy angle as claimed in claim 1, wherein said driving gear is actuated by an air-driven hand-piece for providing motion to said driven gear to actuate said bristles.
